(19) United States
(12) Patent Application Publication
(10) Pub. No.: US 2026/0232034 A1
(43) Pub. Date: Aug. 13, 2026

(54) ATOMIZATION ASSEMBLY, ATOMIZER, AND ELECTRONIC ATOMIZATION APPARATUS

(71) Applicant: HUMBLE GRACE LIMITED, Hong Kong (CN)

(72) Inventors: Yufei TU, Hong Kong (CN); Qing ZUO, Hong Kong (CN); Liwu DUAN, Hong Kong (CN)

(21) Appl. No.: 19/638,119

(22) Filed: Apr. 3, 2026

Related U.S. Application Data
(63) Continuation of application No. PCT/CN2023/138034, filed on Dec. 12, 2023.

(30) Foreign Application Priority Data
Oct. 20, 2023 (CN) 202311364287.1

(51) Int. Cl. A24F 40/485; A24F 40/10; A24F 40/42; A24F 40/44; A24F 40/46; H05B 3/06

(52) U.S. Cl. CPC A24F 40/485; A24F 40/10; A24F 40/42; A24F 40/44; A24F 40/46; H05B 3/06

(57) ABSTRACT

This application discloses an atomization assembly, an atomizer, and an electronic atomization apparatus. The atomization assembly includes a mounting base, a heating element, and a liquid guide member. The mounting base has a first end and a second end arranged oppositely. An air inlet is provided on the first end of the mounting base, and an air outlet is provided on the second end of the mounting base. An atomization channel communicating the air inlet with the air outlet is formed in the mounting base. A mounting space on a side of the atomization channel is further formed in the mounting base. The atomization channel is in communication with the mounting space.

### CROSS-REFERENCE TO RELATED APPLICATIONS

This application is a national stage filing under 35 U.S.C. § 371 of international application number PCT/CN2023/138034, filed on December 12, 2023, which claims priority to Chinese patent application No.202311364287.1, filed on October 20, 2023. The contents of these applications are incorporated herein by reference in their entireties.

### TECHNICAL FIELD

This application relates to the field of electronic atomization technologies, and in particular, to an atomization assembly, an atomizer, and an electronic atomization apparatus.

### BACKGROUND

In an existing electronic atomization apparatus, a heating mesh is usually mounted along an atomization cavity to ensure that when air enters, e-liquid can be heated and atomized by the heating mesh to form aerosol, thereby allowing the aerosol to flow out from an air outlet of the atomization cavity to be inhaled by a user. However, with such a design, air tends to flow directly through the atomization cavity and be inhaled by the user without fully mixing with the aerosol when passing through the heating mesh, resulting in a poor inhalation taste of the electronic atomization apparatus.

### SUMMARY

Embodiments of this application provide an atomization assembly, an atomizer, and an electronic atomization apparatus, so as to improve an atomization effect and improve an inhalation taste.

According to a first aspect, an embodiment of this application provides an atomization assembly, where the atomization assembly includes:

a mounting base, where the mounting base has a first end and a second end arranged oppositely, an air inlet is provided on the first end of the mounting base, an air outlet is provided on the second end of the mounting base, an atomization channel communicating the air inlet with the air outlet is formed in the mounting base, a mounting space located on a side of the atomization channel is further formed in the mounting base, and the atomization channel is in communication with the mounting space;

a heating element, where the heating element is mounted in the mounting space, a heating surface on a side of the heating element is exposed at a communication position between the mounting space and the atomization channel and is arranged obliquely relative to an air intake direction, and the air intake direction is a direction in which airflow flows toward the heating element; and

a liquid guide member, where the liquid guide member is mounted in the mounting space, one end of the liquid guide member is in contact with the heating element, and the other end of the liquid guide member is exposed outside the mounting base, so as to guide an atomization medium from outside the atomization assembly to the heating element.

Optionally, a mounting groove is further formed in the mounting base, a notch of the mounting groove faces a same direction as the air inlet, an avoidance hole is formed on a sidewall of the mounting groove, and the avoidance hole communicates the mounting groove with the mounting space; and

the atomization assembly further includes a conductive elastic piece, and the conductive elastic piece is mounted in the mounting groove in a limited manner and passes through the avoidance hole to contact and be electrically connected to the heating element.

Optionally, the conductive elastic piece includes:

a limiting part, where the limiting part is mounted in the mounting groove in a limited manner and passes through the avoidance hole to abut against the heating element so as to be electrically connected to the heating element; and

an electrical connection part, where the electrical connection part is connected to the limiting part, and the electrical connection part is configured to connect to an electrode connector inserted into the mounting groove so as to be electrically connected to the electrode connector.

Optionally, the heating element includes a liquid buffer part and at least two conductive parts, the liquid buffer part is in contact connection with the liquid guide member and exposed at the communication position between the mounting space and the atomization channel, and the two conductive parts are located on two opposite sides of the liquid buffer part; and

at least two conductive elastic pieces and at least two avoidance holes are provided, and the limiting part of one conductive elastic piece correspondingly passes through one avoidance hole to abut against one conductive part of the heating element.

Optionally, a mounting notch is provided on an outer sidewall of the mounting base, the mounting notch is in communication with the mounting space, the atomization assembly further includes a sealing structure, the sealing structure is accommodated in the mounting notch and the mounting space, the heating element is mounted on a side of the sealing structure close to the atomization channel, and the liquid guide member is mounted on the sealing structure and in contact connection with a side of the heating element away from the atomization channel.

Optionally, the liquid guide member includes:

a first liquid guide part, where the first liquid guide part is mounted on the sealing structure and in contact connection with the side of the heating element away from the atomization channel; and

a second liquid guide part, where the second liquid guide part is mounted on the sealing structure, the second liquid guide part is connected to an end of the first liquid guide part away from the heating element, and an end of the second liquid guide part away from the first liquid guide part is exposed outside the mounting base.

Optionally, the sealing structure includes:

a first fastening member, where the first fastening member is provided with a first fastening hole and an accommodating groove that are in communication with each other, and the second liquid guide part is accommodated in the first fastening hole and exposed outside the second end of the mounting base; and

a second fastening member, where the second fastening member is accommodated in the accommodating groove, a second fastening hole running through a thickness direction of the second fastening member is formed on the second fastening member, and the heating element and the first liquid guide part are mounted in the second fastening hole.

Optionally, a plug-in protrusion is provided on a bottom wall of the accommodating groove, a plug-in slot is provided on a side surface of the second fastening member away from the atomization channel, and the plug-in protrusion is inserted into the plug-in slot.

Optionally, the atomization channel includes:

an air intake section, where a central axis of the air intake section is arranged along a relative direction between the first end of the mounting base and the second end of the mounting base, and the air inlet is located on an end of the air intake section;

an atomization section, where the atomization section is in communication with an end of the air intake section away from the air inlet, and a heating surface on a side of the heating element is exposed in the atomization section; and

an air outlet section, where the air outlet section is in communication with an end of the atomization section away from the air intake section, the air outlet is located on an end of the air outlet section away from the atomization section, and the atomization section is obliquely connected between the air intake section and the air outlet section.

According to a second aspect, this application further provides an atomizer, where the atomizer includes:

a housing;

a base, where the base is covered by the housing; and

the atomization assembly according to the first aspect, where the atomization assembly is connected to the base and located in a space enclosed by the housing and the base.

Optionally, an air outlet tube is formed in the housing, and the base includes:

a blocking member, where the blocking member is inserted into the housing and encloses with the housing to form a liquid reservoir, an insertion hole and a liquid inlet hole are formed on an end of the blocking member facing the liquid reservoir, the air outlet tube is inserted into the insertion hole so as to be in communication with an air outlet of the atomization assembly, and the liquid inlet hole is in communication with the liquid reservoir; and

a limiting mounting member, where the limiting mounting member is in limiting connection with the housing and partially inserted into the blocking member to enclose with the blocking member to form a mounting cavity, the atomization assembly is mounted in the mounting cavity, an air intake channel is formed on the limiting mounting member, and the air intake channel is in communication with an air inlet of the atomization channel.

Optionally, the atomizer further includes at least two electrode connectors, the limiting mounting member is provided with a clearance hole corresponding to each electrode connector, and the electrode connector passes through the clearance hole and is inserted into the mounting base so as to be electrically connected to the heating element.

Optionally, the atomizer further includes a liquid-absorbing member, and the liquid-absorbing member is mounted in the mounting cavity and located between an end of the mounting base on which the air inlet is formed and the limiting mounting member.

Optionally, a surface of the blocking member facing the liquid reservoir is inclined toward a side on which the liquid inlet hole is located.

According to a third aspect, this application further provides an electronic atomization apparatus, where the electronic atomization apparatus includes the atomizer according to the second aspect.

It may be learned that, in the embodiments, the atomization assembly includes a mounting base, a heating element, and a liquid guide member. The mounting base has a first end and a second end arranged oppositely. An air inlet is provided on the first end of the mounting base, and an air outlet is provided on the second end of the mounting base. An atomization channel communicating the air inlet with the air outlet is formed in the mounting base. A mounting space on a side of the atomization channel is further formed in the mounting base. The atomization channel is in communication with the mounting space. The heating element is mounted in the mounting space. A heating surface on a side of the heating element is exposed at a communication position between the mounting space and the atomization channel, and is arranged obliquely relative to an air intake direction. The air intake direction is a direction in which airflow flows toward the heating element. The liquid guide member is mounted in the mounting space, one end of the liquid guide member is in contact with the heating element, and the other end of the liquid guide member is exposed outside the mounting base, so as to guide an atomization medium from outside the atomization assembly to the heating element. Specifically, in this application, liquid stored in the electronic atomization apparatus may be guided to the heating element via the liquid guide member. Thus, when the user inhales and causes gas to flow, the gas flows toward the heating element after entering the atomization assembly from the air inlet, so as to act on the heating surface of the heating element facing the atomization channel, thereby atomizing the liquid under the action of the heating element to form aerosol. In addition, the aerosol flows out of the atomization assembly from the air outlet via the atomization channel, and finally exits the electronic atomization apparatus for the user to inhale.

In this application, by exposing the heating surface on a side of the heating element at the connection position between the mounting space and the atomization channel, arranging the heating surface obliquely relative to the air intake direction, and enabling the air intake direction to be the direction in which airflow flows toward the heating element, gas entering the atomization assembly from the air inlet can flow toward the heating surface of the heating element facing the atomization channel, thereby interacting with the heating element. In this way, it can be ensured that the gas entering the atomization assembly can fully contact the heating element, which helps improve the atomization effect of the heating element on the liquid and improve the taste of the aerosol finally inhaled by the user.

### BRIEF DESCRIPTION OF DRAWINGS

To describe the technical solutions in embodiments of this application or a conventional technology more clearly, the following briefly describes the accompanying drawings required for describing the embodiments or the conventional technology. Clearly, the accompanying drawings in the following description show merely some embodiments of this application, and a person of ordinary skill in the art can still derive other accompanying drawings from these accompanying drawings without creative efforts.

FIG. 1 is a schematic structural diagram of an atomizer according to an embodiment of this application;

FIG. 2 is an exploded view of an atomizer according to an embodiment of this application;

FIG. 3 is a section view of an atomizer according to an embodiment of this application;

FIG. 4 is a schematic structural diagram after a base and an atomization assembly are assembled according to an embodiment of this application;

FIG. 5 is a section view after a base (with a liquid-absorbing member not shown) and an atomization assembly are assembled according to an embodiment of this application;

FIG. 6 is another section view after a base and an atomization assembly are assembled according to an embodiment of this application;

FIG. 7 is a schematic structural diagram of an atomization assembly according to an embodiment of this application;

FIG. 8 is a section view of an atomization assembly according to an embodiment of this application;

FIG. 9 is another section view of an atomization assembly according to an embodiment of this application;

FIG. 10 is a schematic structural diagram of a partial structure of an atomizer according to an embodiment of this application;

FIG. 11 is a schematic structural diagram of a partial structure of an atomization assembly according to an embodiment of this application;

FIG. 12 is a schematic structural diagram of a first fastening member in an atomization assembly according to an embodiment of this application; and

FIG. 13 is a schematic structural diagram of a second fastening member in an atomization assembly according to an embodiment of this application.

### Reference numerals:

1000. atomizer; 100. atomization assembly; 110. mounting base; 110a. first end; 110b. second end; 110c. air inlet; 110d. air outlet; 110e. atomization channel; 110f. mounting space; 110g. mounting groove; 110j. avoidance hole; 110k. mounting notch; 110m. limiting slot; 110p. air intake section; 110q. atomization section; 110r. air outlet section; 120. heating element; 121. liquid buffer part; 122. conductive part; 130. liquid guide member; 131. first liquid guide part; 132. second liquid guide part; 140. conductive elastic piece; 141. limiting part; 1411. main body section; 1412. abutment section; 1413. limiting section; 142. electrical connection part; 1421. connection section; 1422. electrical connection section; 143. connection part; 150. sealing structure; 151. first fastening member; 151a. first fastening hole. 151b. accommodating groove; 1511. plug-in protrusion; 152. second fastening member; 152a. second fastening hole; 152c. plug-in slot; 200. base; 200a. mounting cavity; 200b. liquid outlet hole; 200c. air intake channel; 210. blocking member; 211. plug-in tube; 220. limiting mounting member; 221. mounting part; 222. plug-in part; 223. limiting protrusion; 230. electrode connector; 240. absorbent cotton; 240a. air passage hole; 240b. avoidance notch; 300. housing; 300a. limiting hole; 300b. liquid reservoir; 310. limiting step; 320. air outlet tube; 320a. air outlet channel.

### DESCRIPTION OF EMBODIMENTS

This application provides an atomization assembly 100, where the atomization assembly 100 is applied to an atomizer 1000 of an electronic atomization apparatus, and the electronic atomization apparatus includes a battery assembly and the atomizer 1000. The battery assembly is configured to supply power to the atomization assembly 100 in the atomizer 1000. The battery assembly and the atomizer 1000 may form an undetachable electronic atomization apparatus, or the battery assembly and the atomizer 1000 may form a detachable electronic atomization apparatus, so as to implement replacement of an electronic assembly or the atomization assembly 100 as required.

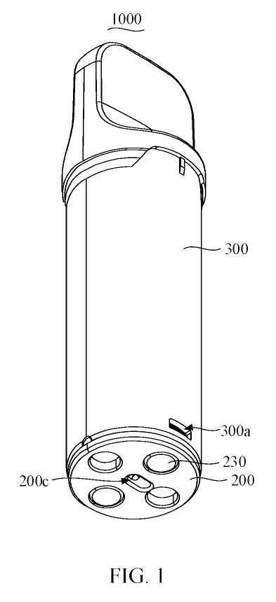

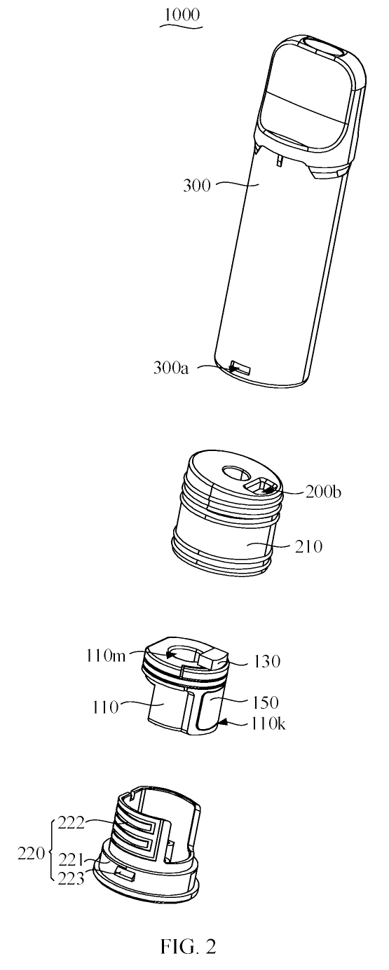

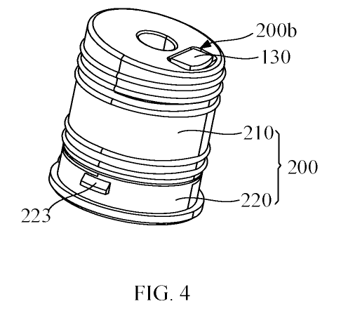

Referring to FIG. 1 to FIG. 13, in this embodiment of this application, the atomization assembly 100 includes a mounting base 110, a heating element 120, and a liquid guide member 130. The mounting base 110 has a first end 110a and a second end 110b arranged oppositely. An air inlet 110c is provided on the first end 110a of the mounting base 110, and an air outlet 110d is provided on the second end 110b of the mounting base 110. An atomization channel 110e communicating the air inlet 110c with the air outlet 110d is formed in the mounting base 110. A mounting space 110f on a side of the atomization channel 110e is further formed in the mounting base 110. The atomization channel 110e is in communication with the mounting space 110f. The heating element 120 is mounted in the mounting space 110f. A heating surface on a side of the heating element 120 is exposed at a communication position between the mounting space 110f and the atomization channel 110e, and is arranged obliquely relative to an air intake direction. The air intake direction is a direction in which airflow flows toward the heating element 120. The liquid guide member 130 is mounted in the mounting space 110f, one end of the liquid guide member 130 is in contact with the heating element 120, and the other end of the liquid guide member 130 is exposed outside the mounting base 110, so as to guide an atomization medium from outside the atomization assembly 100 to the heating element 120.

The heating element 120 may be a structure such as silicon-based atomization core, a heating mesh, a heating plate, or the like. The silicon-based atomization core is a structure in which a heating layer is formed on a surface of a silicon substrate. Specifically, an array of atomization microchannels may be formed on the silicon substrate, symmetrically arranged first oxide layers are provided on opposite side surfaces of the silicon substrate, a second oxide layer is provided on sidewalls of the silicon substrate where the atomization microchannels are formed, and the heating layer is fabricated on a surface of the first oxide layer.

The liquid guide member 130 may be liquid guide cotton. The liquid guide member 130 may be of an integral structure or a separate structure, which is not further limited herein.

The air intake direction specifically refers to a direction in which airflow enters the atomization channel 110e from the air inlet 110c on the first end 110a of the mounting base 110, flows toward the heating element 120, and finally exits from the air outlet 110d on the second end 110b of the mounting base 110.

Specifically, the atomization channel 110e formed in the mounting base 110 is a part of an atomization cavity formed in the electronic atomization apparatus. When flowing through the atomization channel 110e, gas entering the atomization cavity reacts with liquid guided to the heating element 120 by the liquid guide member 130 under the action of the heating element 120, thereby atomizing the liquid to form aerosol. This formed aerosol continues to flow along the atomization cavity toward a user's mouth after exiting the atomization channel 110e, and finally flows out of the electronic atomization apparatus for the user to inhale. The gas entering the atomization cavity may be air.

Specifically, the atomization channel 110e formed in the mounting base 110 includes at least two channel sections, and a single channel section has only one central axis direction. When the atomization channel 110e includes two channel sections, one channel section is a portion of the atomization channel 110e where airflow enters the atomization channel 110e along the air intake direction, and the other channel section is a portion of the atomization channel 110e that exposes a heating surface on a side of the heating element 120.

It may be learned that in this embodiment, the atomization assembly 100 includes a mounting base 110, a heating element 120, and a liquid guide member 130. The mounting base 110 has a first end 110a and a second end 110b arranged oppositely. An air inlet 110c is provided on the first end 110a of the mounting base 110, and an air outlet 110d is provided on the second end 110b of the mounting base 110. An atomization channel 110e communicating the air inlet 110c with the air outlet 110d is formed in the mounting base 110. A mounting space 110f on a side of the atomization channel 110e is further formed in the mounting base 110. The atomization channel 110e is in communication with the mounting space 110f. The heating element 120 is mounted in the mounting space 110f. A heating surface on a side of the heating element 120 is exposed at a communication position between the mounting space 110f and the atomization channel 110e, and is arranged obliquely relative to an air intake direction. The air intake direction is a direction in which airflow flows toward the heating element 120. The liquid guide member 130 is mounted in the mounting space 110f, one end of the liquid guide member 130 is in contact with the heating element 120, and the other end of the liquid guide member 130 is exposed outside the mounting base 110, so as to guide an atomization medium from outside the atomization assembly 100 to the heating element 120. Specifically, in this application, liquid stored in the electronic atomization apparatus may be guided to the heating element 120 via the liquid guide member 130. Thus, when the user inhales and causes gas to flow, the gas flows toward the heating element 120 after entering the atomization assembly 100 from the air inlet 110c, so as to act on the heating surface of the heating element 120 facing the atomization channel 110e, thereby atomizing the liquid under the action of the heating element 120 to form aerosol. In addition, the aerosol flows out of the atomization assembly 100 from the air outlet 110d via the atomization channel 110e, and finally exits the electronic atomization apparatus for the user to inhale. In this application, by exposing the heating surface on a side of the heating element 120 at the connection position between the mounting space 110f and the atomization channel 110e, arranging the heating surface obliquely relative to the air intake direction, and enabling the air intake direction to be the direction in which airflow flows toward the heating element 120, gas entering the atomization assembly 100 from the air inlet 110c can flow toward the heating surface of the heating element 120 facing the atomization channel 110e, thereby interacting with the heating element 120. In this way, it can be ensured that the gas entering the atomization assembly 100 can fully contact the heating element 120, which helps improve the atomization effect of the heating element 120 on the liquid and improves the taste of the aerosol finally inhaled by the user.

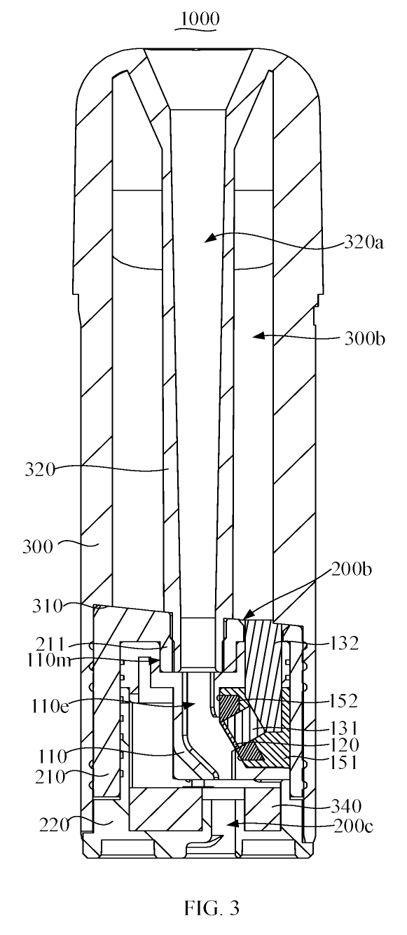

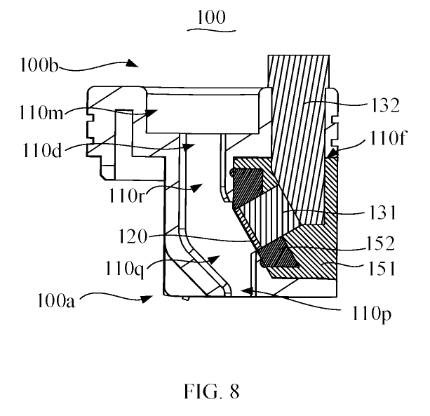

Referring to FIG. 3 and FIG. 8, in a possible example, the atomization channel 110e includes an air intake section 110p, an atomization section 110q, and an air outlet section 110r. A central axis of the air intake section 110p is arranged along a relative direction between the first end 110a of the mounting base 110 and the second end 110b of the mounting base 110. The air intake section 110c is located on an end of the air intake section 110p. The atomization section 110q communicates with an end of the air intake section 110p away from the air inlet 110c, and a heating surface on a side of the heating element 120 is exposed in the atomization section 110q. The air outlet section 110r communicates with an end of the atomization section 110q away from the air intake section 110p. The air outlet 110d is located on an end of the air outlet section 110r away from the atomization section 110q. In addition, the atomization section 110q is obliquely connected between the air intake section 110p and the air outlet section 110r.

The relative direction between the first end 110a of the mounting base 110 and the second end 110b of the mounting base 110 includes a direction from the first end 110a of the mounting base 110 facing the second end 110b, and a direction from the second end 110b of the mounting base 110 facing the first end 110a. It can be learned that in this example, the air intake direction is the direction from the first end 110a toward the second end 110b of the mounting base 110 in the axial direction of the central axis of the air intake section 110p.

Specifically, in this example, a heating surface on a side of the heating element 120 may be arranged obliquely with respect to the air inlet 110c, and projections of the heating surface and the air inlet 110c along the air intake direction partially overlap. Therefore, the heating surface of the heating element 120 facing the atomization channel 110e can be obliquely oriented toward the air inlet 110c and positioned directly above the air inlet 110c along a gas flow direction. In this way, after gas enters the atomization channel 110e from the air inlet 110c, the gas can first flow directly to the heating surface of the heating element 120.

It can be learned that in this example, by designing the atomization channel 110e to have three sections and exposing the heating element 120 in the middle atomization section 110q, the heating surface of the heating element 120 can be positioned directly above the air inlet 110c, better facing the air inlet 110c. This ensures that after entering the atomization channel 110e from the air inlet 110c, airflow flows directly to the heating surface of the heating element 120, thereby achieving thorough mixing of air and aerosol. This not only improves the atomization effect but also shortens the response time of the heating element 120, finally improving the atomization efficiency of the atomization assembly 100.

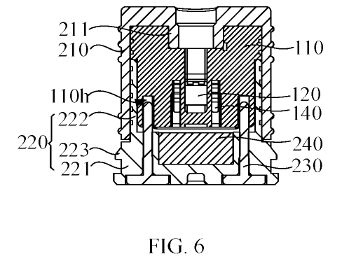

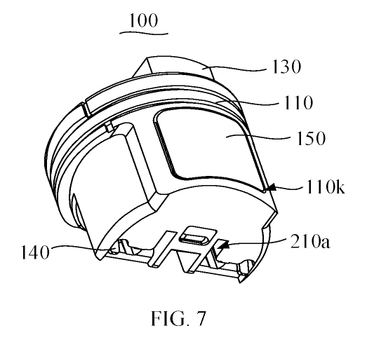

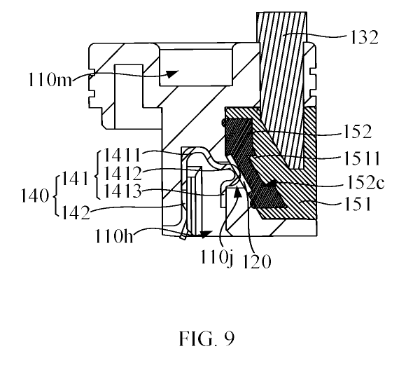

Referring to FIG. 6, FIG. 7, and FIG. 9, in a possible example, the mounting base 110 is further formed with a mounting groove 110h. A notch of the mounting groove 110h and the air inlet 110c face a same direction, and a sidewall of the mounting groove 110h is formed with an avoidance hole 110j. The avoidance hole 110j communicates the mounting groove 110h with the mounting space 110f. The atomization assembly 100 further includes a conductive elastic piece 140. The conductive elastic piece 140 is mounted in the mounting groove 110h in a limited manner and passes through the avoidance hole 110j to contact the heating element 120, thereby establishing an electrical connection.

The conductive elastic piece 140 is configured to electrically connect the heating element 120 and the electrode connector 230, and the electrode connector 230 is configured to be connected to a battery cell in a battery assembly of the electronic atomization apparatus. The provision of the avoidance hole 110j allows the conductive elastic piece 140 mounted in the mounting groove 110h to extend into the mounting space 110f and come into contact with the heating element 120 in the mounting space 110f, thereby establishing an electrical connection to the heating element 120. This ensures that the battery assembly of the electronic atomization apparatus can supply power to the heating element 120.

The notch of the mounting groove 110h and the air inlet 110c face the same direction, which indicates that the notch of the mounting groove 110h faces the first section of the mounting base 110, in other words, faces the direction of the battery assembly of the electronic atomization apparatus. This can improve the mounting convenience of the battery assembly and the conductive elastic piece 140.

Specifically, mounting the conductive elastic piece 140 in the mounting groove 110h in a limited manner can further improve mounting stability of the conductive elastic piece 140, thereby ensuring reliability of an electrical connection to the heating element 120.

It can be learned that in this example, using elasticity of the conductive elastic piece 140 to fasten the conductive elastic piece 140 in the mounting groove 110h in a limited manner can improve both mounting convenience and reliability of the conductive elastic piece 140. In addition, the conductive elastic piece 140 is connected to the heating element 120 after passing through the avoidance hole 110j, so that the heating element 120 can be energized to heat up by using the conductive elastic piece 140, thereby improving convenience of connecting to the battery assembly of the electronic atomization apparatus by the heating element 120 and reliability of an electrical connection.

Referring to FIG. 9 to FIG. 11, in a possible example, the conductive elastic piece 140 includes a limiting part 141 and an electrical connection part 142. The limiting part 141 is mounted in the mounting groove 110h in a limited manner and passes through the avoidance hole 110j to abut against the heating element 120, thereby establishing an electrical connection to the heating element 120. The electrical connection part 142 is connected to the limiting part 141, and the electrical connection part 142 is configured to connect to an electrode connector 230 inserted into the mounting groove 110h, thereby establishing an electrical connection to the electrode connector 230.

The electrode connector 230 is an element connected to a battery electrode of the battery assembly, and is configured to guide a current provided by the battery assembly to the conductive elastic piece 140.

Specifically, the limiting part 141 may include a main body section 1411, an abutment section 1412, and a limiting section 1413. The main body section 1411 is formed by bending, a first bent part of the main body section 1411 abuts against a groove sidewall of the mounting groove 110h, and a second bent part of the main body section 1411 is connected to an end of the first bent part, and abuts against a groove bottom wall of the mounting groove 110h, so as to position a mounting position of the conductive elastic piece 140. The abutment section 1412 is bent and connected to an end of the second bent part of the main body section 1411 away from the first bent part. In this way, the abutment section 1412 is positioned and aligned with the avoidance hole 110j, and passes through the avoidance hole 110j to contact the heating element 120. A part of the limiting part 141 inserted into the avoidance hole 110j may be limited and fastened by the limiting hole 300a, so as to implement limiting of the conductive elastic piece 140 in the relative direction between the first end 110a and the second end 110b of the mounting base 110. The limiting section 1413 is bent and connected to an end of the abutment section 1412 away from the main body section 1411, and abuts against a groove sidewall on a side opposite to the groove sidewall abutted against by the first bent part. Thus, in conjunction with the first bent part, limiting of the conductive elastic piece 140 in a direction perpendicular to the central axis of the mounting groove 110h is implemented, thereby further improving stability of mounting the conductive elastic piece 140 in the mounting groove 110h in a limited manner.

Further, the abutment section 1412 of the limiting part 141 may further be bent to form an arc section, so that the abutment section 1412 can slightly deform when inserted into the avoidance hole 110j, and abuts against two opposite side surfaces of the avoidance hole 110j, thereby further improving stability of mounting the conductive elastic piece 140 in the mounting groove 110h in a limited manner.

Specifically, the electrical connection part 142 includes a connection section 1421 and an electrical connection section 1422. The connection section 1421 is configured to be connected to the limiting part 141 (that is, connected to an end of the main body section 1411 of the limiting part 141 away from the abutment section 1412). The electrical connection section 1422 is connected to an end of the connection section 1421 away from the limiting part 141. The electrical connection section 142 is configured to be electrically connected to the electrode connector 230 inserted into the mounting groove 110h, so as to establish an electrical connection between the battery assembly and the heating element 120. Specifically, a part of the electrode connector 230 inserted into the mounting groove 110h may be clamped between the electrical connection part 142 and the groove sidewall of the mounting groove 110h in a limited manner, so as to implement mounting and fastening of the electrode connector 230, thereby ensuring mounting stability of the electrode connector 230.

Further, a bent section may be formed in the electrical connection part 142, and a protruding portion of the bent section may abut against the electrode connector 230, so as to clamp the electrode connector 230 between the electrical connection part 142 and the groove sidewall of the mounting groove 110h in a limited manner, thereby further improving mounting stability of the electrode connector 230.

In a specific implementation, a shape of the mounting groove 110h may be adapted to a shape design of the conductive elastic piece 140, so as to reduce the space occupied by the mounting groove 110h and improve mounting stability of the conductive elastic piece 140.

In a specific implementation, the limiting part 141 may be directly connected to the electrical connection part 142, so as to simplify a structure of the conductive elastic piece 140. Alternatively, in a specific implementation, the conductive elastic piece 140 may further include a connection part 143. One end of the connection part 143 is connected to the limiting part 141 (the end of the main body section 1411 of the limiting part 141 away from the abutment section 1412), and the other end of the connection part 143 is connected to the electrical connection part 142 (the end of the connection section 1421 of the electrical connection part 142 away from the electrical connection section 1422). The connection part 143 may extend in the direction perpendicular to the central axis of the mounting groove 110h, so that the limiting part 141 and the electrical connection part 142 are staggered from each other in the direction perpendicular to the central axis of the mounting groove 110h. This prevents a part of the mounting groove 110h corresponding to the limiting part 141 from being excessively large, which affects stability of connection and fastening of the electrical connection part 142.

In a specific implementation, during mounting, the conductive elastic piece 140 may be inserted from the notch of the mounting groove 110h. In this case, the limiting part 141 is compressed and deformed by the sidewall of the mounting groove 110h. As an insertion depth changes, when the limiting part 141 is inserted to the position of the avoidance hole 110j, the limiting part 141 is no longer compressed and deformed by the sidewall of the mounting groove 110h and resets. In this case, the limiting part 141 is inserted into the avoidance hole 110j during reset from deformation, abuts against the heating element 120, and is fastened in a limited manner at the part of the mounting base 110 forming the avoidance hole 110j.

It can be learned that in this example, the conductive elastic piece 140 can be fastened in the mounting groove 110h in a limited manner by using the limiting part 141, thereby improving mounting convenience and reliability of the conductive elastic piece 140. Through the connection between the electrical connection part 142 and the battery cell of the electrode connector 230, and by enabling the limiting part 141 connected to the electrical connection part 142 to pass through the avoidance hole 110j to abut against the heating element 120, it can be ensured that the heating element 120 can be electrically connected to the electrode connector 230, thereby ensuring that the battery assembly can stably supply power to the heating element 120.

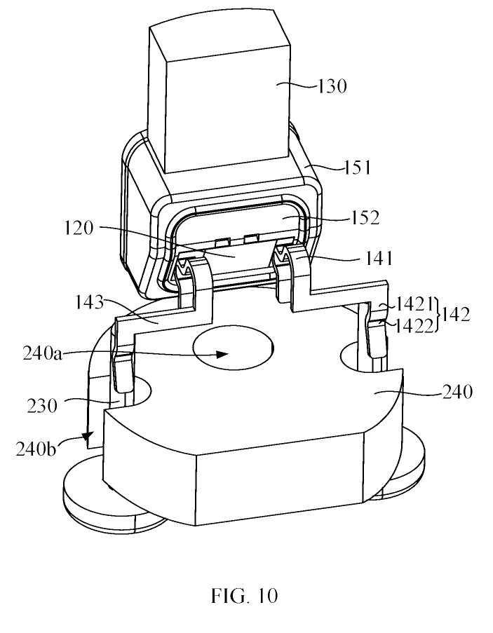

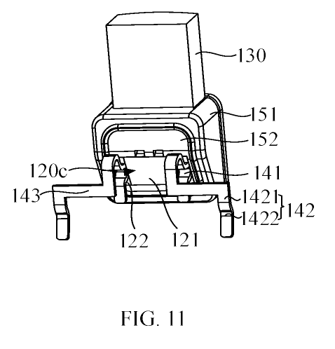

Referring to FIG. 10 and FIG. 11, in a possible example, the heating element 120 includes a liquid buffer part 121 and at least two conductive parts 122. The liquid buffer part 121 is in contact connection with the liquid guide member 130 and is exposed at the communication position between the mounting space 110f and the atomization channel 110e. The at least two conductive parts 122 are located on two opposite sides of the liquid buffer part 121. At least two conductive elastic pieces 140 are provided, and at least two avoidance holes 110j are provided. The limiting part 141 of one conductive elastic piece 140 correspondingly passes through one avoidance hole 110j to abut against one conductive part 122 of the heating element 120.

The liquid buffer part 121 of the heating element 120 can store a small quantity of liquid introduced by the liquid guide cotton, and the liquid buffer part 121 of the heating element 120 is formed with a channel for the liquid to enter the atomization channel 110e after atomization, thereby ensuring that aerosol generated by liquid atomization can flow out of the atomization channel 110e and is finally inhaled by the user.

Specifically, if the heating element 120 is of a two-electrode structure, the heating element 120 includes two conductive parts 122, and the two conductive parts 122 are respectively connected to two electrodes of the battery in the battery assembly. The two conductive parts 122 are respectively located on the two opposite sides of the liquid buffer part 121, so that the conductive elastic piece 140 is easily connected. In this case, two conductive elastic pieces 140 and two avoidance holes 110j are also correspondingly provided. Alternatively, if the heating element 120 is of a three-electrode structure, the heating element 120 includes three conductive parts 122, and two conductive parts 122 of the three conductive parts 122 are connected to a same electrode of the battery in the battery assembly. The three conductive parts 122 are located on the two opposite sides of the liquid buffer part 121, and two conductive parts 122 are provided on a side of the liquid buffer part 121. In this case, three conductive elastic pieces 140 and three avoidance holes 110j are also correspondingly provided.

Specifically, the mounting groove 110h may be a single slot capable of simultaneously accommodating at least two conductive elastic pieces 140 for insertion, or the mounting groove 110h may be provided according to a quantity of conductive elastic pieces 140, so that one conductive elastic piece 140 is correspondingly inserted into one mounting groove 110h.

It can be learned that in this example, by arranging at least two conductive elastic pieces 140 to respectively connect the heating element 120 to the positive electrode and the negative electrode of the battery in the battery assembly, occurrence of circuit operation disorder can be avoided, and working reliability of the heating element 120 can be improved. In addition, arranging at least two conductive parts 122 of the heating element 120 on the two opposite sides of the liquid buffer part 121 not only allows for a more uniform structural design of the heating element 120 but also improves convenience of contact between the conductive elastic piece 140 and the heating element, while reducing the possibility of an electrical connection between the at least two conductive parts 122.

Referring to FIG. 7 to FIG. 9, in a possible example, a mounting notch 110k is provided on an outer side wall of the mounting base 110, the mounting notch 110k is in communication with the mounting space 110f, the atomization assembly 100 further includes a sealing structure 150, the sealing structure 150 is accommodated in the mounting notch 110k and the mounting space 110f, the heating element 120 is mounted on a side of the sealing structure 150 close to the atomization channel 110e, and the liquid guide member 130 is mounted on the sealing structure 150 and in contact connection with a side of the heating element away from the atomization channel 110e.

The sealing structure 150 may be made of elastic sealing material, which prevents liquid leakage while ensuring stability of mounting and fastening of the heating element 120 and the liquid guide member 130.

Specifically, during mounting, the sealing structure 150 may be inserted into the mounting space 110f by using the mounting notch 110k, so as to be fastened in the mounting space 110f, thereby ensuring that the liquid guide member 130 and the heating element 120 can be fastened in the mounting space 110f, and preventing leakage of liquid introduced by the liquid guide member 130.

In a specific implementation, the mounting notch 110k may be provided on a circumferential side surface of the mounting base 110. In this way, the sealing structure 150 can be inserted into the mounting space 110f by using the mounting notch 110k, and the sealing structure 150 can be prevented from falling in the relative direction between the first end 110a and the second end 110b of the mounting base 110, thereby ensuring mounting stability of the mounting structure.

It can be learned that, in this example, arranging the mounting notch 110k can improve convenience of assembling the atomization assembly 100, reduce a difficulty of assembling the atomization assembly 100, and improve assembling efficiency of the electronic atomization apparatus in an assembly process.

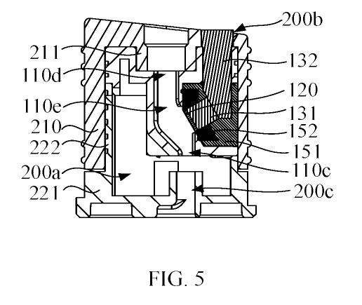

Referring to FIG. 3, FIG. 5, and FIG. 8, in a possible example, the liquid guide member 130 includes a first liquid guide part 131 and a second liquid guide part 132. The first liquid guide part 131 is mounted on the sealing structure 150 and is in contact connection with the side of the heating element 120 away from the atomization channel 110e. The second liquid guide part 132 is mounted on the sealing structure 150, and the second liquid guide part 132 is connected to an end of the first liquid guide part 131 away from the heating element 120. An end of the second liquid guide part 132 away from the first liquid guide part 131 is exposed outside the mounting base 110.

Both the first liquid guide part 131 and the second liquid guide part 132 may be liquid guide cotton. The second liquid guide part 132 is configured to draw out the liquid stored in the liquid reservoir 300b of the electronic atomization apparatus, and the first liquid guide part 131 is configured to guide the liquid drawn out by the second liquid guide part 132 to the liquid buffer part 121 of the heating element 120. Arranging the second liquid guide part 132 to protrude from the second end 110b of the mounting base 110 can ensure that the second liquid guide part 132 can be exposed within the liquid reservoir 300b of the electronic atomization apparatus.

In a specific implementation, permeability of the first liquid guide part 131 may be lower than that of the second liquid guide part 132. This causes the liquid to slow down when guided by the second liquid guide part 132 from the liquid reservoir 300b to the first liquid guide part 131, thereby preventing a problem of liquid leaking from the atomization channel 110e due to an amount of liquid guided by the first liquid guide part 131 to the heating element 120 exceeding an amount of liquid consumed during operation of the heating element 120.

It can be learned that in this example, the liquid guide member 130 is arranged to include the first liquid guide part 131 and the second liquid guide part 132, so that the speed at which the second liquid guide part 132 guides the liquid to the first liquid guide part 131 can be slowed down, thereby reducing the liquid delivery speed and preventing liquid leakage.

Referring to FIG. 3, FIG. 5, and FIG. 7 to FIG. 13, in a possible example, the sealing structure 150 includes a first fastening member 151 and a second fastening member 152. The first fastening member 151 is provided with a first fastening hole 151a and an accommodating groove 151b that are in communication with each other. The second liquid guide part 132 is accommodated in the first fastening hole 151a and is exposed outside the second end 110b of the mounting base 110. The second fastening member 152 is accommodated in the accommodating groove 151b. The second fastening member 152 is formed with a second fastening hole 152a running through a thickness direction of the second fastening member 152. The heating element 120 and the first liquid guide part 131 are mounted in the second fastening hole 152a.

Specifically, a hole axis of the first fastening hole 151a may be arranged along a height direction of the mounting base 110. In this way, it can be ensured that, during use, the liquid in the liquid reservoir 300b can flow toward the second liquid guide part 132 under the action of gravity. A central axis of the second fastening hole 152a is perpendicular to a heating surface of the heating element 120, that is, the hole axis of the second fastening hole 152a is perpendicular to the heating surface of the heating element 120. In this way, it can be ensured that the first liquid guide part 131 mounted in the second fastening hole 152a can guide the liquid from the second liquid guide part 132 to the liquid buffer part 121 of the heating element 120. Specifically, a distance from the heating element 120 to the second end 110b of the mounting base 110 can be made greater than a distance from an abutment position between the second liquid guide part 132 and the first liquid guide part 131 to the second end 110b of the mounting base 110. Therefore, when the electronic atomizer 1000 is in use, the heating element 120 is positioned lower than the first liquid guide part 131, ensuring that, in the absence of external force, the first liquid guide part 131 can continuously guide the liquid to the heating element 120.

In a specific implementation, during assembly, the heating element 120 and the first liquid guide part 131 may first be mounted in the second fastening hole 152a of the second fastening member 152. Then, the assembled second fastening member 152 is inserted into the accommodating groove 151b of the first fastening member 151. Afterwards, the assembled first fastening member 151 and second fastening member 152 are inserted via the mounting notch 110k into the mounting space 110f of the mounting base 110, thereby mounting the heating element 120 and the first liquid guide part 131 in the mounting space 110f. After the first fastening member 151 and the second fastening member 152 are mounted in the mounting space 110f, then the second liquid guide part 132 may be inserted from the second end 110b of the mounting base 110 into the mounting base 110, and inserted in the first fastening hole 151a of the first fastening member 151, with a part exposed outside the mounting base 110, thereby limiting the first fastening member 151 and the second fastening member 152 and preventing the first fastening member 151 and the second fastening member 152 from sliding out through the mounting notch 110k.

Further, on a side of the first fastening member 151 where the heating element 120 is exposed, and at positions adjacent to two opposite sides of the first fastening hole 151a, a placement slot (not shown in the figure) may be separately formed. Both sides of the heating element 120 where the conductive parts 122 are formed are respectively placed in a placement slot, so as to fasten the heating element 120 in a limited manner between a bottom wall of the placement slot and an inner sidewall of a part of the mounting base 110 forming the mounting space 110f, and to prevent the liquid guided by the first liquid guide part 131 from directly contacting the conductive parts 122 and causing electrical leakage.

It can be learned that in this example, by configuring the sealing structure 150 as two separate structures, namely the first fastening member 151 and the second fastening member 152, assembly of the atomization assembly 100 is facilitated, and stability of each component in the atomization assembly 100 after assembly is improved.

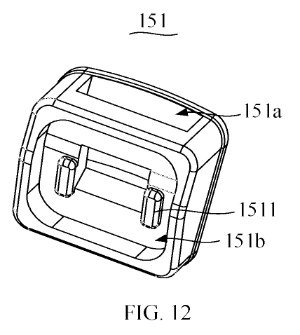

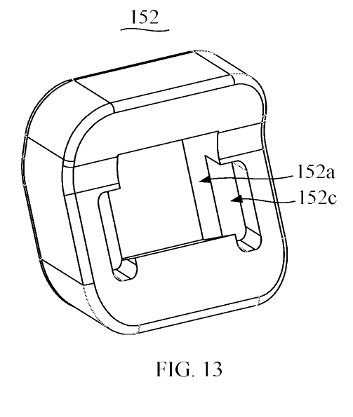

Referring to FIG. 9, FIG. 12, and FIG. 13, in a possible example, a plug-in protrusion 1511 is provided on a bottom wall of the accommodating groove 151, a plug-in slot 152c is provided on a side surface of the second fastening member 152 away from the atomization channel 110e, and the plug-in protrusion 1511 is inserted into the plug-in slot 152c.

In a specific implementation, in a process of assembling the first fastening member 151 and the second fastening member 152, when the second fastening member 152 is inserted into the accommodating groove 151b of the first fastening member 151, the plug-in protrusion 1511 of the first fastening member 151 may be aligned and inserted into the plug-in slot 152c of the second fastening member 152.

Specifically, at least two groups of plug-in protrusions 1511 and plug-in slots 152c may be correspondingly provided, where at least two plug-in slots 152c may be arranged at equal intervals along a circumferential direction of the second fastening hole 152a to ensure structural balance. In addition, arranging the plug-in slots 152c along the circumferential direction of the second fastening hole 152a also allows the plug-in protrusions 1511 provided on the first fastening member 151 to further limit the first liquid guide part 131 after assembly, thereby improving mounting stability of the first liquid guide part 131. In addition, such an arrangement enables the circumferential direction of the second fastening hole 152a to have a hole position facilitating gripping, so as to facilitate disassembly of the first liquid guide part 131.

It can be learned that in this example, by providing the plug-in protrusion 1511 on the bottom wall of the accommodating groove 151b of the first fastening member 151 and correspondingly providing the plug-in slot 152c on the second fastening member 152, positioning can be achieved during assembly of the first fastening member 151 and the second fastening member 152, and connection stability between the first fastening member 151 and the second fastening member 152 can be further improved.

Referring to FIG. 1 to FIG. 13, this application further provides an atomizer 1000. The atomizer 1000 includes a housing 300, a base 200, and an atomization assembly 100. The base 200 is covered by the housing 300, and the atomization assembly 100 is connected to the base 200, and is located in a space enclosed by the housing 300 and the base 200.

An air outlet channel 320a is formed in the housing 300, an air intake channel 200c is formed in the base 200, the air intake channel 200c is in communication with an air inlet 110c of the atomization channel 110e, and an air outlet 110d of the atomization assembly 100 is in communication with the air outlet channel 320a. The air outlet channel 320a formed in the housing 300, the atomization channel 110e formed in the atomization assembly 100, and the air intake channel 200c formed in the base 200 are in communication with each other to form an atomization cavity of the atomizer 1000.

Specifically, when in use, gas may enter from the air intake channel 200c and flow toward the air inlet 110c of the atomization assembly 100. After entering the atomization channel 110e from the air inlet 110c, the gas flows toward the heating surface of the heating element 120, so that liquid is atomized under the action of the heating element 120. Aerosol generated by liquid atomization flows along the atomization channel 110e, enters the air outlet channel 320a through the outlet port 110d of the atomization channel 110e, and finally exits the atomizer 1000 along the air outlet channel 320a for a user to inhale.

In a specific implementation, the atomization assembly 100 may be connected to the housing 300, and encloses with the housing 300 to form a liquid reservoir 300b, and the base 200 is mounted on a side of the atomization assembly 100 away from the liquid reservoir 300b. Alternatively, the liquid reservoir 300b may be enclosed by the base 200 and the housing 300. In this case, a mounting cavity 200a may be formed in the base 200, and the atomization assembly 100 is mounted in the mounting cavity 200a. In this case, a side of the base 200 facing the liquid reservoir 300b is further formed with a liquid outlet hole 200b in communication with the liquid reservoir 300b, and the second liquid guide part 132 is exposed in the liquid outlet hole 200b.

It can be learned that in this example, for a specific structure of the atomization assembly 100, refer to the foregoing embodiment. Because the atomizer 1000 uses all technical solutions of all the foregoing embodiments of the atomization assembly 100, the atomizer 1000 has at least all beneficial effects brought by the technical solutions of the foregoing embodiments. Details are not described herein again.

Referring to FIG. 3 to FIG. 6, in a possible example, an air outlet tube 320 is formed in the housing 300. The base 200 includes a blocking member 210 and a limiting mounting member 220. The blocking member 210 is inserted into the housing 300, and encloses with the housing 300 to form the liquid reservoir 300b. An insertion hole and a liquid inlet hole are formed on an end of the blocking member 210 facing the liquid reservoir 300b. The air outlet tube 320 is plugged into the insertion hole so as to communicate with the air outlet 110d of the atomization assembly 100, and the liquid inlet hole communicates with the liquid reservoir 300b. The limiting mounting member 220 is connected to the housing 300 in a limited manner and is partially inserted into the blocking member 210, so as to enclose with the blocking member 210 to form the mounting cavity 200a. The atomization assembly 100 is mounted in the mounting cavity 200a. The air intake channel 200c is formed in the limiting mounting member 220, and the air intake channel 200c communicates with the air inlet 110c of the atomization channel 110e.

The blocking member 210 is configured to block an open end of the housing 300, and may enclose with the housing 300 to form the liquid reservoir 300b. The limiting mounting member 220 is configured to be connected to the open end of the housing 300 in a limited manner, so as to fasten the blocking member 210 and the atomization assembly 100 in a limited manner, preventing the blocking member 210 from sliding out of the open end of the housing 300, thereby ensuring stability of structural connection of atomizer 1000. The air outlet channel 320a is formed in the air outlet tube 320 formed in the housing 300, and the air outlet channel 320a is configured to guide atomized aerosol to flow out of the atomizer 1000 when the user inhales.

Specifically, the housing 300 has an air outlet end and an open end arranged opposite each other. A limiting step 310 is formed on the open end of the housing 300. A side surface of the blocking member 210 facing the liquid reservoir 300b abuts against a step surface of the limiting step 310. The limiting step 310 may provide positioning for mounting of the blocking member 210 and fasten the blocking member 210 in a limited manner between the limiting step 310 and the limiting mounting member 220.

Specifically, the second end 110b of the mounting base 110 is formed with a limiting slot 110m, and the air outlet 110d is formed on a bottom wall of the limiting slot 110m. The blocking member 210 is formed with a plug-in tube 211, and the plug-in tube 211 is inserted into the limiting slot 110m. The limiting slot 110m is configured to position the blocking member 210 and the atomization assembly 100 during assembly and can improve structural stability of the blocking member 210 and the atomization assembly 100 after assembly. The air outlet tube 320 is inserted into the plug-in tube 211. Inserting the air outlet tube 320 into the plug-in tube 211 not only can provide positioning for mounting of the housing 300 and the blocking member 210, but also can ensure that the air outlet 110d of the atomization assembly 100 can be aligned and in communication with the air outlet channel 320a, thereby ensuring connectivity of the atomization cavity.

Specifically, the open end of the housing 300 is further formed with a limiting hole 300a, a limiting protrusion 223 is provided on a circumferential outer surface of the limiting mounting member 220, and the limiting protrusion 223 is inserted into the limiting hole 300a. In this way, the limiting mounting member 220 can be fastened on the second end of the housing 300, preventing the base 200 from detaching from the housing 300.

Specifically, the limiting mounting member 220 may include a mounting part 221 and a plug-in part 222, and the plug-in part 222 is connected to the mounting part 221. The limiting protrusion 223 is provided in the mounting part 221, and the plug-in part 222 is configured to be inserted into the blocking member 210, so as to enclose with the blocking member 210 to form the circumferential side surface of the mounting cavity 200a. An end portion of the plug-in part 222 away from the mounting part 221 may also abut against the mounting base 110, so as to fasten the atomization assembly 100 in a limiting position, thereby further improving stability of the base 200 after assembly.

It can be learned that in this example, the main body of the base 200 is configured as two separate structures, namely the blocking member 210 and the limiting mounting member 220, so as to mount the atomization assembly 100 in the mounting cavity 200a formed by the base 200. This modularizes the base 200 and the atomization assembly 100, thereby facilitating assembly of the atomizer 1000 and improving convenience of assembling the atomizer 1000. In addition, the main body of the base 200 can further protect the atomization assembly 100.

Referring to FIG. 6 and FIG. 10, in a possible example, the atomizer 1000 further includes at least two electrode connectors 230, the limiting mounting member 220 is provided with a clearance hole corresponding to each electrode connector 230, and the electrode connector 230 passes through the clearance hole and is inserted into the mounting base 110 so as to be electrically connected to the heating element 120.

The at least two electrode connectors 230 may be respectively connected to the positive electrode and the negative electrode of the battery in the battery assembly, and one electrode connector 230 is in contact with one conductive elastic piece 140.

Specifically, during mounting, the electrode connector 230 may be inserted from a side of the limiting mounting member 220 away from the air inlet 110c of the mounting base 110, pass through the clearance hole, and be exposed on a side of the limiting mounting member 220 facing the air inlet 110c of the mounting base 110. Then, the electrode connector 230 may be inserted into the mounting groove 110h of the mounting base 110, positioned in a partial space of the mounting groove 110h used for limiting the electrode connector 230. Subsequently, the conductive elastic piece 140 may be inserted from the notch of the mounting groove 110h, so that the electrical connection part 142 of the conductive elastic piece 140 is inserted into the partial space of the mounting groove 110h used for limiting the electrode connector 230, is in contact with the electrode connector 230 to conduct electricity, and limits the electrode connector 230 between the electrical connection part 142 and the side wall of the mounting groove 110h.

It can be learned that in this example, the electrode connector 230 is inserted into the mounting groove 110h of the mounting base 110 through the limiting mounting member 220, so as to be electrically connected to the heating element 120, thereby improving convenience of connecting the heating element 120 to the external battery assembly.

Referring to FIG. 3, FIG. 6, and FIG. 10, in a possible example, the atomizer 1000 further includes a liquid-absorbing member, and the liquid-absorbing member is mounted in the mounting cavity 200a and located between an end of the mounting base 110 where the air inlet 110c is formed and the limiting mounting member 220.

The liquid-absorbing member may be absorbent cotton 240. The liquid-absorbing member may cover a side surface of the limiting mounting member 220 facing the mounting base 110 and where the air inlet 110c is formed.

Specifically, the liquid-absorbing member may form a mounting hole or an avoidance notch 240b for the electrode connector 230 to pass through, to facilitate insertion of the electrode connector 230 through the liquid-absorbing member into the mounting groove 110h formed in the mounting base 110. Further, the side of the limiting mounting member 220 facing the air inlet 110c of the mounting base 110 is formed with a mounting tube in communication with the clearance hole. The mounting tube can further limit the insertion direction and position of the electrode connector 230 and improve mounting stability of the electrode connector 230. The mounting hole formed in the liquid-absorbing member may be sleeved around the mounting tube, so that the mounting tube provides positioning for mounting of the liquid-absorbing member and limits the absorbent cotton 240.

Specifically, an air inlet tube is formed on a side of the limiting mounting member 220 facing the air inlet 110c of the mounting base 110, and the air intake channel 200c is formed in the air inlet tube. An air passage hole 240a is further formed in the absorbent cotton 240 at a position corresponding to the air inlet 110c of the mounting base 110. The air passage hole 240a is sleeved over the air inlet tube to ensure communication between the air intake channel 200c and the air inlet 110c.

It can be learned that in this example, by mounting a liquid-absorbing member between the end of the mounting base 110 where the air inlet 110c is formed and the limiting mounting member 220, the liquid-absorbing member can accommodate and absorb the liquid formed by condensation of the aerosol generated after atomization but not inhaled by the user. This prevents the condensed liquid from leaking through the air intake channel 200c, thereby improving reliability of the atomizer 1000 in use.

Referring to FIG. 3 and FIG. 5, in a possible example, a surface of the blocking member 210 facing the liquid reservoir 300b is inclined toward a side on which the liquid inlet hole is located.

Specifically, the surface of the blocking member 210 facing the liquid reservoir 300b may be inclined from the second end 110b of the mounting base 110 toward the first end 110a, and the liquid inlet hole is located at a position on the surface of the blocking member 210 facing the liquid reservoir 300b and close to the first end 110a.

Specifically, the surface of the blocking member 210 facing the liquid reservoir 300b is the bottom of the liquid reservoir 300b, and the side of the liquid reservoir 300b facing the outlet end of the housing 300 is the top of the liquid reservoir 300b. That is, when the atomizer 1000 is in use (that is, when the atomizer 1000 is positioned according to the relative direction between the first end 110a and the second end 110b of the mounting base 110), the liquid outlet hole 200b will be located in a lower region or a lowest region at the bottom of the liquid reservoir 300b.

It can be learned that in this example, by inclining the surface of the blocking member 210 facing the liquid reservoir 300b toward the side on which the liquid inlet hole is located, it can be ensured that when the atomizer 1000 is used in a vertical direction, the liquid outlet hole 200b is located in a lower region at the bottom of the liquid reservoir 300b. This can ensure that the liquid in the liquid reservoir 300b can be fully and completely utilized.

This application further provides an electronic atomization apparatus. The electronic atomization apparatus includes an atomization assembly 100. For a specific structure of the atomization assembly 100, refer to the foregoing embodiment. Because the electronic atomization apparatus uses all technical solutions of all the foregoing embodiments of the atomization assembly 100, the electronic atomization apparatus has at least all beneficial effects brought by the technical solutions of the foregoing embodiments. Details are not described herein again.

Specifically, the electronic atomization apparatus may include a battery assembly and an atomization structure, where the battery assembly is configured to supply power to a heating element 120 in the atomization assembly 100. The atomization structure includes the atomization assembly 100. A specific structure of the atomization structure may be the same as or different from that of the atomizer 1000 in the foregoing example, and may be specifically set according to an actual requirement, which is not further limited herein. When the atomization structure is the atomizer 1000, because the electronic atomization apparatus uses all technical solutions of all the foregoing embodiments of the atomizer 1000, the electronic atomization apparatus has at least all beneficial effects brought by the technical solutions of the foregoing embodiments. Details are not described herein again.

What is claimed is:

1. An atomization assembly, wherein the atomization assembly comprises:
a mounting base, wherein the mounting base has a first end and a second end arranged oppositely, an air inlet is provided on the first end of the mounting base, an air outlet is provided on the second end of the mounting base, an atomization channel communicating the air inlet with the air outlet is formed in the mounting base, a mounting space located on a side of the atomization channel is further formed in the mounting base, and the atomization channel is in communication with the mounting space;
a heating element, wherein the heating element is mounted in the mounting space, a heating surface on a side of the heating element is exposed at a communication position between the mounting space and the atomization channel and is arranged obliquely relative to an air intake direction, and the air intake direction is a direction in which airflow flows toward the heating element; and
a liquid guide member, wherein the liquid guide member is mounted in the mounting space, one end of the liquid guide member is in contact with the heating element, and the other end of the liquid guide member is exposed outside the mounting base, so as to guide an atomization medium from outside the atomization assembly to the heating element.

2. The atomization assembly according to claim 1, wherein a mounting groove is further formed in the mounting base, a notch of the mounting groove faces a same direction as the air inlet, an avoidance hole is formed on a sidewall of the mounting groove, and the avoidance hole communicates the mounting groove with the mounting space; and
the atomization assembly further comprises a conductive elastic piece, and the conductive elastic piece is mounted in the mounting groove in a limited manner and passes through the avoidance hole to contact and be electrically connected to the heating element.

3. The atomization assembly according to claim 2, wherein the conductive elastic piece comprises:
a limiting part, wherein the limiting part is mounted in the mounting groove in a limited manner and passes through the avoidance hole to abut against the heating element so as to be electrically connected to the heating element; and
an electrical connection part, wherein the electrical connection part is connected to the limiting part, and the electrical connection part is configured to connect to an electrode connector inserted into the mounting groove so as to be electrically connected to the electrode connector.

4. The atomization assembly according to claim 3, wherein the heating element comprises a liquid buffer part and at least two conductive parts, the liquid buffer part is in contact connection with the liquid guide member and exposed at the communication position between the mounting space and the atomization channel, and the two conductive parts are located on two opposite sides of the liquid buffer part; and
at least two conductive elastic pieces and at least two avoidance holes are provided, and the limiting part of one conductive elastic piece correspondingly passes through one avoidance hole to abut against one conductive part of the heating element.

5. The atomization assembly according to claim 1, wherein a mounting notch is provided on an outer sidewall of the mounting base, the mounting notch is in communication with the mounting space, the atomization assembly further comprises a sealing structure, the sealing structure is accommodated in the mounting notch and the mounting space, the heating element is mounted on a side of the sealing structure close to the atomization channel, and the liquid guide member is mounted on the sealing structure and in contact connection with a side of the heating element away from the atomization channel.

6. The atomization assembly according to claim 5, wherein the liquid guide member comprises:
a first liquid guide part, wherein the first liquid guide part is mounted on the sealing structure and in contact connection with the side of the heating element away from the atomization channel; and
a second liquid guide part, wherein the second liquid guide part is mounted on the sealing structure, the second liquid guide part is connected to an end of the first liquid guide part away from the heating element, and an end of the second liquid guide part away from the first liquid guide part is exposed outside the mounting base.

7. The atomization assembly according to claim 6, wherein the sealing structure comprises:
a first fastening member, wherein the first fastening member is provided with a first fastening hole and an accommodating groove that are in communication with each other, and the second liquid guide part is accommodated in the first fastening hole and exposed outside the second end of the mounting base; and
a second fastening member, wherein the second fastening member is accommodated in the accommodating groove, a second fastening hole running through a thickness direction of the second fastening member is formed on the second fastening member, and the heating element and the first liquid guide part are mounted in the second fastening hole.

8. The atomization assembly according to claim 7, wherein a plug-in protrusion is provided on a bottom wall of the accommodating groove, a plug-in slot is provided on a side surface of the second fastening member away from the atomization channel, and the plug-in protrusion is inserted into the plug-in slot.

9. The atomization assembly according to claim 1, wherein the atomization channel comprises:
an air intake section, wherein a central axis of the air intake section is arranged along a relative direction between the first end of the mounting base and the second end of the mounting base, and the air inlet is located on an end of the air intake section;
an atomization section, wherein the atomization section is in communication with an end of the air intake section away from the air inlet, and a heating surface on a side of the heating element is exposed in the atomization section; and
an air outlet section, wherein the air outlet section is in communication with an end of the atomization section away from the air intake section, the air outlet is located on an end of the air outlet section away from the atomization section, and the atomization section is obliquely connected between the air intake section and the air outlet section.

10. An atomizer, wherein the atomizer comprises:
a housing;
a base, wherein the base is covered by the housing; and
the atomization assembly according to claim 1, wherein the atomization assembly is connected to the base and located in a space enclosed by the housing and the base.

11. The atomizer according to claim 10, wherein an air outlet tube is formed in the housing, and the base comprises:
a blocking member, wherein the blocking member is inserted into the housing and encloses with the housing to form a liquid reservoir, an insertion hole and a liquid inlet hole are formed on an end of the blocking member facing the liquid reservoir, the air outlet tube is inserted into the insertion hole so as to be in communication with an air outlet of the atomization assembly, and the liquid inlet hole is in communication with the liquid reservoir; and
a limiting mounting member, wherein the limiting mounting member is in limiting connection with the housing and partially inserted into the blocking member to enclose with the blocking member to form a mounting cavity, the atomization assembly is mounted in the mounting cavity, an air intake channel is formed on the limiting mounting member, and the air intake channel is in communication with an air inlet of the atomization channel.

12. The atomizer according to claim 11, wherein the atomizer further comprises at least two electrode connectors, the limiting mounting member is provided with a clearance hole corresponding to each electrode connector, and the electrode connector passes through the clearance hole and is inserted into the mounting base so as to be electrically connected to the heating element.

13. The atomizer according to claim 11, wherein the atomizer further comprises a liquid-absorbing member, and the liquid-absorbing member is mounted in the mounting cavity and located between an end of the mounting base on which the air inlet is formed and the limiting mounting member.

14. The atomizer according to claim 11, wherein a surface of the blocking member facing the liquid reservoir is inclined toward a side on which the liquid inlet hole is located.

15. An electronic atomization apparatus, wherein the electronic atomization apparatus comprises the atomizer according to claims claim 10.

16. The electronic atomization apparatus according to claim 15, wherein an air outlet tube is formed in the housing, and the base comprises:
a blocking member, wherein the blocking member is inserted into the housing and encloses with the housing to form a liquid reservoir, an insertion hole and a liquid inlet hole are formed on an end of the blocking member facing the liquid reservoir, the air outlet tube is inserted into the insertion hole so as to be in communication with an air outlet of the atomization assembly, and the liquid inlet hole is in communication with the liquid reservoir; and
a limiting mounting member, wherein the limiting mounting member is in limiting connection with the housing and partially inserted into the blocking member to enclose with the blocking member to form a mounting cavity, the atomization assembly is mounted in the mounting cavity, an air intake channel is formed on the limiting mounting member, and the air intake channel is in communication with an air inlet of the atomization channel.

17. The electronic atomization apparatus according to claim 16, wherein the atomizer further comprises at least two electrode connectors, the limiting mounting member is provided with a clearance hole corresponding to each electrode connector, and the electrode connector passes through the clearance hole and is inserted into the mounting base so as to be electrically connected to the heating element.

18. The electronic atomization apparatus according to claim 16, wherein the atomizer further comprises a liquid-absorbing member, and the liquid-absorbing member is mounted in the mounting cavity and located between an end of the mounting base on which the air inlet is formed and the limiting mounting member.

19. The electronic atomization apparatus according to claim 16, wherein a surface of the blocking member facing the liquid reservoir is inclined toward a side on which the liquid inlet hole is located.
